(19) United States
(12) Patent Application Publication
(10) Pub. No.: US 2006/0150832 A1
(43) Pub. Date: Jul. 13, 2006

(54) Foliage compactor

(76) Inventor: Grover Miller, Peninsula, OH (US)

Correspondence Address: BROUSE MCDOWELL LPA, 388 SOUTH MAIN STREET, SUITE 500, AKRON, OH, 44311, US

(21) Appl. No.: 11/033,650

(22) Filed: Jan. 12, 2005

(51) Int. Cl. B30B 5/00

(52) U.S. Cl. 100/240; 100/100

(57) ABSTRACT

A foliage compactor includes a feed chute and compactor tube that houses a single platen for use in compacting associated foliage or other similar debris. The compactor uses a hydraulic cylinder and pump to cycle the platen back and forth thereby compacting the foliage against the sides of the compacting tube. A vacuum pump is included that draws the foliage through a conduit into the compacting chamber.

### 1. BACKGROUND OF THE INVENTION

A. Field of Invention

This invention pertains to the art of methods and apparatuses for a mobile foliage compactor, and more specifically, to a mobile foliage compactor that includes a vacuum suction device and a hydraulically actuated platen.

2. Brief History

It is known in the art to compact material of various kinds, such as hay or straw or leaves or other organic material. The use of labor to collect, gather and dispose of the material can be costly, especially in light of rapidly rising cost of manual labor. Alternatively, there are devices available that can be used to collect and dispose of leaves and the like. However, these devices are typically quite large and cannot be used in a commercial or residential setting. These devices are furthermore complex and costly placing them out of reach for commercial or residential users.

Additionally, it is desirable to bale material in the densest bale possible because storage and shipping costs are based on volume rather than weight. If a particular material will permit compressing into high-density bales especially for long-distance shipping this may appreciably lower shipping costs, which will make the product more price-competitive in its destination market. Therefore storage and shipping costs will be lower with denser bales. However, once again these machines are typically very large and include complex mechanical systems that process and compact the material. What is needed is a small, mobile foliage compactor that can bale foliage in highly dense bales that can be used in a commercial or residential setting.

### 3. SUMMARY OF THE INVENTION

One aspect of this invention includes an organic leaf compactor, includes a generally longitudinal compactor frame; at least a first ground engaging wheel rotatably connected with respect to the compactor frame; a hitch fixedly connected to a first end of the compactor frame for use in selectively attaching the compactor to an associated riding lawn mower; a generally tubular feed chute having first and second ends; a compactor tube having first and second ends, wherein the second end of the feed chute is operatively communicated to the first end of the compactor tube; a self-contained internal combustion engine having a first power output; a hydraulic pump operatively communicated to the first power output; a hydraulic cylinder operatively communicated to the hydraulic pump, the hydraulic cylinder having a cylinder rod; a single platen fixedly connected to the cylinder rod, wherein the platen is received at least partially within the first end of the compactor tube; a hydraulic control valve operatively communicated between the hydraulic pump and the hydraulic cylinder for use in controlling the speed of travel of the hydraulic cylinder; and, a vacuum pump operatively connected to the compactor frame, the vacuum pump having a first vacuum output operatively communicated to the feed chute for use in drawing associated debris into the feed chute.

Another aspect of this invention includes an organic debris compactor, that includes a rigid frame; at least a first ground engaging wheel operatively connected to the frame; an engine for use in supplying power to the compactor, the engine being fixedly attached to the frame, the engine having at least a first power output; at least a first prime mover operatively communicated to the at least a first power output of the engine; an organic debris feed chute having first and second ends; an organic debris compacting tube having first and second ends, wherein the second end of the feed chute is juxtaposed to the first end of the compacting tube for use in conveying associated organic debris to the compacting tube; and, a single platen selectively moveably connected with respect to a longitudinal axis of the compacting tube, the platen being operatively connected to the prime mover, wherein the platen is received at least partially within the first end of the compacting tube.

Yet another aspect of this invention includes a hitch fixedly connected to the frame, the hitch extending from a first end of the frame for use in selectively attaching the organic debris compactor to an associated riding lawn mower.

Still yet another aspect of this invention includes a hydraulic cylinder, and a hydraulic pump operatively fixedly connected to the frame, the hydraulic pump being operatively communicated to the hydraulic cylinder.

Yet another aspect of this invention includes a hydraulic control valve operatively communicated between the hydraulic pump and the hydraulic cylinder for use in selectively controlling the speed of movement of the hydraulic cylinder.

Still yet another aspect of this invention includes a vacuum pump fixedly connected to the frame, the vacuum having at least a first vacuum output.

Yet another aspect of this invention includes a flexible suction tube operatively connected to the at least a first vacuum output for use in vacuuming up associated organic debris.

Still yet another aspect of this invention includes a flexible suction tube having first and second ends, the first end of the flexible suction tube being operatively connected to the first end of the organic debris feed chute; and, mower deck connecting means operatively attached to the second end of the flexible suction tube for use in connecting the flexible suction tube to an associated mower deck.

Still yet another aspect of this invention includes a second end of the compacting tube that is tapered with respect to the first end of the compacting tube.

Yet another aspect of this invention includes a compacting tube is comprised of first and second longitudinal portions, and, tensioning means for use in compressing the first and second longitudinal portions together, the tensioning means being operatively connected to the first and second longitudinal portions.

Still yet another aspect of this invention includes a tensioning means is at least a first spring operatively connected to the first and second longitudinal portions.

### 4. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a side view of a foliage compactor.

FIG. 2 is a cross sectional view of foliage compactor.

FIG. 3 is a cutaway perspective view of a compactor tube of a foliage compactor.

FIG. 4 is a side view of a foliage compactor flexible foliage conduit.

### 5. DESCRIPTION OF THE PREFERRED EMBODIMENT

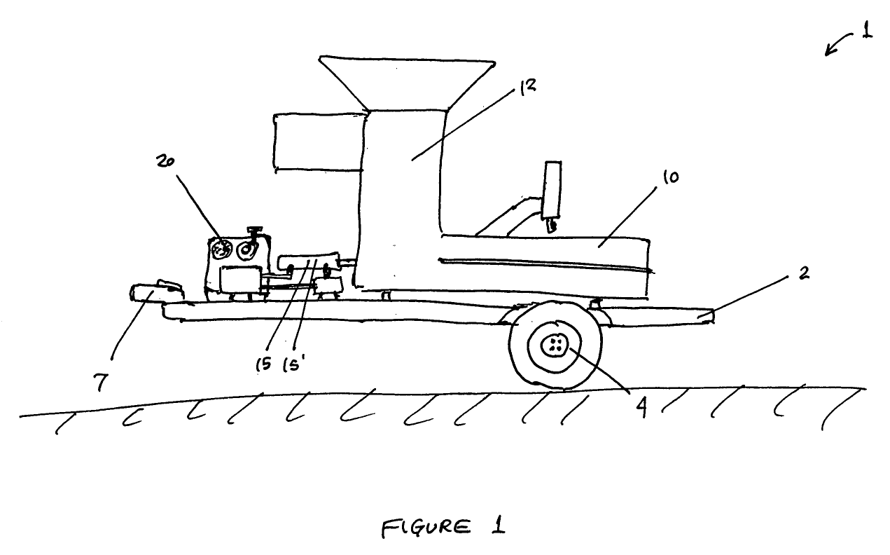

Referring now to the drawings wherein the showings are for purposes of illustrating a preferred embodiment of the invention only and not for purposes of limiting the same, FIG. 1 shows a mobile foliage compactor shown generally at 1. The foliage compactor 1 may include a frame 2 having one or more ground engaging wheels 4. In the preferred embodiment, the ground engaging wheels 4 provide a way for the foliage compactor 1 to be moved from one location to another during use. Accordingly, one end of the frame 2 may include a hitch 7 for connecting the frame to an associated vehicle, not shown, which may be a riding lawn mower. In this manner, the mobile foliage compactor 1 may be used commercially or residentially on any turf where leaves or other foliage may fall. The foliage compactor 1 may additionally include a compacting tube 10 and adjacently positioned foliage feed tube 12. Foliage or organic debris entering the feed tube 12 may be channeled to the compacting tube 10 where a compacting device, such as a platen 18, may be cycled back and forth for use in compacting associated foliage, as will be discussed in detail in a subsequent paragraph. A force driving means 15 may be included that cycles or moves the platen 18 in and out of the compacting tube 10. As more foliage is fed into the device 1, a bail of highly compressed foliage is formed into any desired size. An engine 20 may be included that provides power to drive the platen 18.

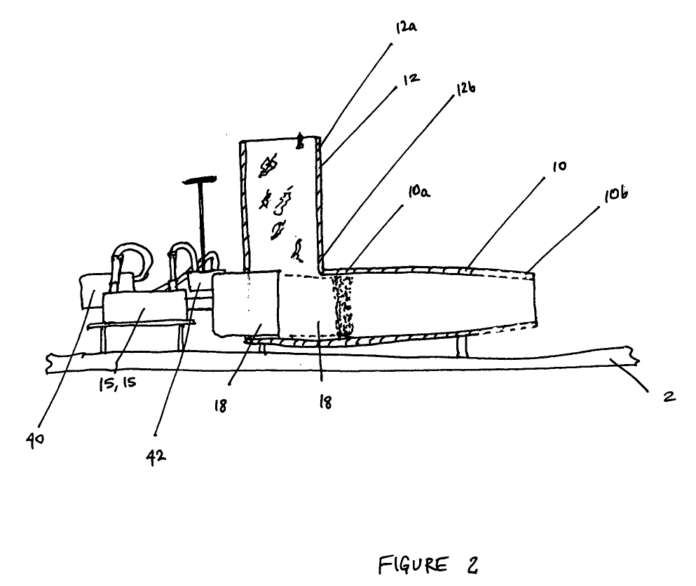

With continued reference to FIG. 1 and now to FIG. 2, a cross section of the feed tube 12 and compacting tube 10 is shown. The feed tube 12 may have first 12a and second 12b ends respectively. Likewise, the compacting tube 10 may also have first 10a and second 10b ends respectively. In one embodiment, the feed tube 12 may be juxtaposed at substantially 90 degrees with respect to the compacting tube 10. The feed tube 12 may also be positioned substantially vertically, wherein the compacting tube 10 is then positioned substantially horizontally. However, any angle or orientation of feed tube 12 and compacting tube 10 may be chosen with sound engineering judgment. It is noted here that the feed tube 12 and compacting tube 10 are presently described as separate items or pieces. However, it is within the scope of the present invention that the feed tube 12 and compacting tube 10 be constructed as a single piece formed in the manner described herein. Continuing, the platen 18, as mentioned above, may be slidably connected with respect to the compacting tube 10. As shown in the Figures, the platen 18 may move into and out of the first end 10a of the compacting tube region. This allows the associated foliage to fall in front of the platen 18 when the platen 18 is in the rearward position. As the platen 18 is cycled forward the associated foliage is then compacted. It is especially noted that the foliage is compacted without the use of a second platen. Rather the foliage is compacted only against the sides of the compacting tube. In one embodiment, the compacting tube 10 may be tapered. That is to say that the cross section of the first end 10a of the compacting tube 10 may be larger than the cross section of the second end 10b of the compacting tube 10. Slits may be formed in the walls of the compacting tube 10 for use in allowing a binder to bind the bails of compacted foliage together, as will be discussed further in a subsequent paragraph.

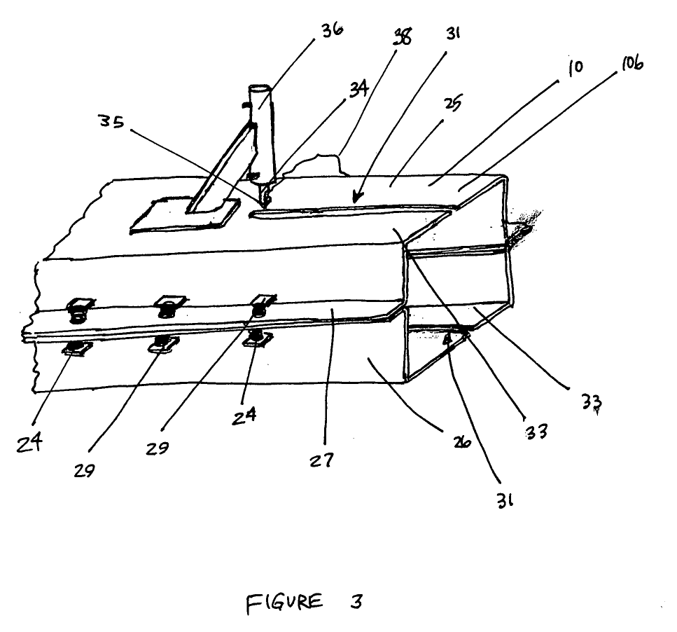

With continued reference to FIG. 2 and now to FIG. 3, a close up view of the second end 10b of the compacting tube 10 is shown. In one embodiment, the compacting tube 10 may include top and bottom portions 25, 26 respectively that may be held together via a plurality of springs 24. In one embodiment, four (4) springs may be used on each side of compacting tube 10. However, any number of springs 24 may be chosen with sound engineering for use with the present invention. The springs 24 may be positioned between a flange 27 of the top 25 or bottom 26 portions and a bracket member 29. The bracket member 29 may be selectively adjustable to change the tension of the springs 24 as desired. In order to make the adjustments, the bracket member 29 may include a threaded portion that screws into and out of the flange 27. However, any configuration of bracket member 29 and flange 27 may be chosen with sound engineering judgment that allows the bracket member 29 to be adjustable with respect to the flange 27. In this manner, the force of the tapered walls of the compacting tube 10 against the associated foliage may be selectively adjustable.

With continued reference to FIG. 2 and to FIG. 3, in each of the top 25 and bottom 26 portions, slits 31 may be fashioned in the walls 33 of portions 25, 26. The slits 31 may extend a length L from the second end 10b of the compacting tube 10, wherein any length L maybe chosen with sound engineering judgment. In one embodiment, the length L may be shorter than the overall length of the compacting tube 10. More specifically, the length L may be 0.5 times the length of the compacting tube 10. The width W of the slits 31 may be sufficiently wide to receive a rod 34 that may be used to insert a binding cord 38 through the compacted foliage, as will be discussed below. The rod 34 may be mounted within a sleeve 36 that allows the rod 34 to move between first and second positions. In the first position, the rod 34 may be positioned outside the compacting tube 10 and above the slits 31. In the second position, the rod 34 may be inserted or driven through the slits 31 into the compacting tube and extending out the distal side of the compacting tube 10. In this manner, the rod 34 and the binding cord 38 are inserted into the bale of compacted material. It is to be construed that the sleeve 36 is fixedly connected to the frame 2 or compacting tube 10 via welding, fasteners or any other means chosen with sound engineering judgment. In one embodiment, the rod 34 may connected to a driving means, such as a hydraulic or pneumatic cylinder and may be selectively moved between the first and second positions by actuating the cylinder. The rod 34 may also include a hook portion 35 for use in receiving the binding cord 38. In this manner, the binding cord 38 may be placed onto the hook portion 35 and driven through the compacted foliage for use in binding the bails together.

With reference again to FIG. 2, as previously mentioned a force driving means 15 may be connected to the platen 18 for use in moving the platen 18 in and out of the first end 10a of the compacting tube 10. In one embodiment, the force driving means 15 may be a hydraulic cylinder 15′ mounted to the frame 2 of the compactor 1. The hydraulic cylinder 15′ may include a cylinder rod, not shown, that is fixedly connected to the platen 18 such that when the cylinder is actuated in and out, the platen 18 may also be moved in and out. A hydraulic pump 40 may also be included to provide fluid power to drive the cylinder 15′. Additionally, a control valve 42 may be connected within the hydraulic fluid circuit and between the hydraulic pump 40 and the cylinder 15′. The control valve 42 may include a spool, not shown, that can be selectively adjusted to limit flow to the cylinder 15′. A handle extending upward from the valve 42 may control the valve spool position. In this manner, the speed of travel of the cylinder rod, and correspondingly the platen 18, may be selectively controlled by adjusting the control valve 42. However, any configuration of hydraulic cylinder, control valves, hydraulic pumps, conduit, manifolds and the like may be chosen with sound engineering judgment. It is also noted here that other means for driving the platen 18 may include but is not limited to pneumatics; mechanicals gear boxes and the like. The engine 20, as mentioned earlier, may be an internal combustion engine 20 that provides power to drive the hydraulic pump 40 or other driving means 15. In this manner, the mobile foliage compactor 1 may be self-contained to provide power to operate the compactor 1. In that the use and operation of internal combustion engines is well known in the art, no further explanation will be offered at this time.

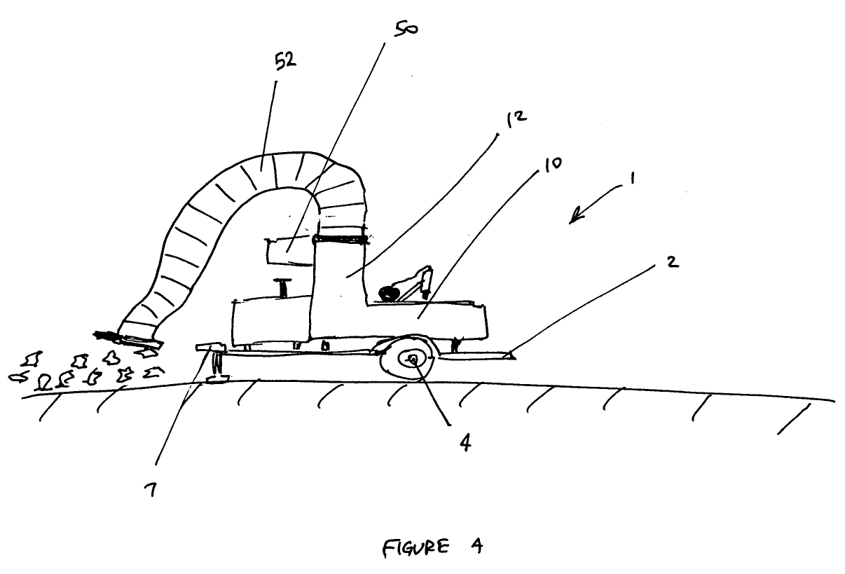

With reference now to FIG. 4, a flexible foliage conduit 52 is shown connected to the first end 12a of the feed tube 12. The foliage conduit 52 may extend from the first end 12a of the feed tube 12 to the surrounding ground region in proximity to the compactor 1. Any length of foliage conduit 52 may be chosen with sound engineering judgment as is appropriate for use with the present invention. A vacuum pump 50 may also be included with the foliage compactor 1. In one embodiment, the vacuum pump 50 may be connected to the feed tube 12 and the flexible foliage conduit 52. In this manner, when the vacuum pump 50 is turned on, suction from the pump 50 draws foliage from the surrounding ground through the foliage conduit 52 and into the feed tube 12. The vacuum pump 50 may draw power to operate from the onboard engine 20. In one embodiment, an electrical generating device, such as an alternator, not shown, may be included that converts power from the engine 20 into electrical energy that may be utilized by the vacuum pump 50. However, any means of providing or converting power to operate the vacuum pump 50 may be chosen with sound engineering judgment. It is also contemplated in an alternate embodiment, that the foliage conduit 52 may be connected at one end to the feed tube 12 and at the other end to the output of a mower deck. In that the compactor 1 may be connected via the hitch to a riding mower, the foliage conduit 52 may extend to the mower deck of the riding mower. In this manner, foliage or debris jettisoned from the mower deck may be channeled through the conduit 52 and into the compactor 1. To note in summary, there may be at least three ways to introduce foliage into the feed tube 12 of the foliage compactor 1: manually deposit foliage directly into the feed tube, vacuum suction foliage through the foliage conduit and channel foliage through the conduit from an associated mower deck.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

I/We claim:

1. An organic leaf compactor, comprising:
a generally longitudinal compactor frame;
at least a first ground engaging wheel rotatably connected with respect to the compactor frame;
a hitch fixedly connected to a first end of the compactor frame for use in selectively attaching the compactor to an associated riding lawn mower;
a generally tubular feed chute having first and second ends;
a compactor tube having first and second ends, wherein the second end of the feed chute is operatively communicated to the first end of the compactor tube;
a self-contained internal combustion engine having a first power output;
a hydraulic pump operatively communicated to the first power output;
a hydraulic cylinder operatively communicated to the hydraulic pump, the hydraulic cylinder having a cylinder rod;
a single platen fixedly connected to the cylinder rod, wherein the platen is received at least partially within the first end of the compactor tube;
a hydraulic control valve operatively communicated between the hydraulic pump and the hydraulic cylinder for use in controlling the speed of travel of the hydraulic cylinder; and,
a vacuum pump operatively connected to the compactor frame, the vacuum pump having a first vacuum output operatively communicated to the feed chute for use in drawing associated debris into the feed chute.

2. An foliage compactor, comprising:
a rigid frame;
at least a first ground engaging wheel operatively connected to the frame;
an engine for use in supplying power to the compactor, the engine being fixedly attached to the frame, the engine having at least a first power output;
at least a first prime mover operatively communicated to the at least a first power output of the engine;
an organic debris feed chute having first and second ends;
an organic debris compacting tube having first and second ends, wherein the second end of the feed chute is juxtaposed to the first end of the compacting tube for use in conveying associated organic debris to the compacting tube; and,
a single platen selectively moveably connected with respect to a longitudinal axis of the compacting tube, the platen being operatively connected to the prime mover, wherein the platen is received at least partially within the first end of the compacting tube.

3. The foliage compactor of claim 2, further comprising:
a hitch fixedly connected to the frame, the hitch extending from a first end of the frame for use in selectively attaching the organic debris compactor to an associated riding lawn mower.

4. The foliage compactor of claim 3, wherein the prime mover is a hydraulic cylinder, and further comprising:
a hydraulic pump operatively fixedly connected to the frame, the hydraulic pump being operatively communicated to the hydraulic cylinder.

5. The foliage compactor of claim 4, further comprising:
a hydraulic control valve operatively communicated between the hydraulic pump and the hydraulic cylinder for use in selectively controlling the speed of movement of the hydraulic cylinder.

6. The foliage compactor of claim 2, further comprising:
a vacuum pump fixedly connected to the frame, the vacuum having at least a first vacuum output.

7. The foliage compactor of claim 5, further comprising:
a flexible suction tube operatively connected to the at least a first vacuum output for use in vacuuming up associated organic debris.

8. The foliage compactor of claim 2, further comprising:
a flexible suction tube having first and second ends, the first end of the flexible suction tube being operatively connected to the first end of the organic debris feed chute; and,
mower deck connecting means operatively attached to the second end of the flexible suction tube for use in connecting the flexible suction tube to an associated mower deck.

9. The foliage compactor of claim 6, wherein the second end of the compacting tube is tapered with respect to the first end of the compacting tube.

10. The foliage compactor of claim 9, wherein the compacting tube is comprised of first and second longitudinal portions, and,
further comprising:
tensioning means for use in compressing the first and second longitudinal together, the tensioning means being operatively connected to the first and second longitudinal portions.

11. The foliage compactor of claim 10, wherein the tensioning means is at least a first spring operatively connected to the first and second longitudinal portions.
